(19) United States
(12) Patent Application Publication
(10) Pub. No.: US 2021/0202996 A1
(43) Pub. Date: Jul. 1, 2021

(54) NON-AQUEOUS ELECTROLYTE, NON-AQUEOUS ELECTROLYTE SECONDARY BATTERY AND METHOD FOR THE SAME

(71) Applicant: Toyota Jidosha Kabushiki Kaisha, Toyota-shi Aichi-ken (JP)

(72) Inventor: Hiroto Asano, Nisshin-shi (JP)

(73) Assignee: Toyota Jidosha Kabushiki Kaisha, Toyota-shi Aichi-ken (JP)

(21) Appl. No.: 16/952,879

(22) Filed: Nov. 19, 2020

(30) Foreign Application Priority Data
Dec. 27, 2019 (JP) 2019-238261

(51) Int. Cl. H01M 10/0568; H01M 10/0525; H01M 10/0569

(52) U.S. Cl. CPC H01M 10/0568; H01M 10/0525; H01M 2300/002; H01M 2300/0028; H01M 10/0569

(57) ABSTRACT

A non-aqueous electrolyte disclosed herein contains a difluorophosphate represented by the following formula (I) with 0.5% by mass or more and an organic sulfate ester salt represented by the following formula (II) with 0.1% by mass or more. M⁺ in the following formula (I) represents an alkali metal ion. M⁺ in the following formula (II) is a quaternary ammonium cation or a nitrogen-containing heteroaromatic ring cation, and R is an alkyl group having one to five carbon atoms in which an ether oxygen is optionally inserted.

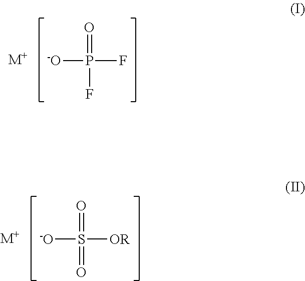

### CROSS REFERENCE TO RELATED APPLICATIONS

This nonprovisional application claims priority to Japanese Patent Application No. 2019-238261 filed on Dec. 27, 2019, with the Japan Patent Office, which is incorporated herein by reference in its entirety.

### BACKGROUND

### 1. Technical Field

The disclosure relates to a non-aqueous electrolyte used for a secondary battery. The disclosure also relates to a non-aqueous electrolyte secondary battery constructed using the non-aqueous electrolyte and a method for manufacturing a non-aqueous electrolyte secondary battery.

### 2. Description of Related Art

Secondary batteries are used as a power source for a wide range of applications. Particularly in recent years, a high-output and high-capacity secondary battery has been adopted as a vehicle driving power source or a power storing power source for electric vehicles (EVs), hybrid vehicles (HVs), plug-in hybrid vehicles (PHVs), and the like. Examples of such a secondary battery include a lithium ion secondary battery or a sodium ion secondary battery, in which a charge carrier is a predetermined metal ion and an electrolyte is an organic (non-aqueous) electrolyte, that is, a non-aqueous electrolyte. Further improvement in the used non-aqueous electrolyte can be considered as an approach to improve the performance of such a non-aqueous electrolyte secondary battery. For example, Japanese Unexamined Patent Application Publication No. 11-067270 (JP 11-067270 A) describes a non-aqueous electrolyte containing lithium monofluorophosphate or lithium difluorophosphate for reducing self-discharge characteristics and improve storage characteristics. Further, Japanese Unexamined Patent Application Publication No. 2011-187440 (JP 2011-187440 A) describes a non-aqueous electrolyte containing a fluorosulfonate having a predetermined structure for the purpose of improving the initial charge capacity, input/output characteristics and impedance characteristics.

### SUMMARY

However, according to a study made by the inventor, the non-aqueous electrolytes described in JP 11-067270 A and JP 2011-187440 A still have room for improvement. Particularly, a secondary battery to be used as a vehicle driving power source requires reduction in the initial resistance in an extremely low temperature range (here, a range of 0° C. or lower) to improve the input/output characteristics, as well as improvement in high temperature storage characteristics (high temperature durability). There is a need for development of a non-aqueous electrolyte that can realize the functions described above. The disclosure provides a non-aqueous electrolyte secondary battery and a non-aqueous electrolyte for the secondary battery which can improve the input/output characteristics in an extremely low temperature range. In addition to the improvement in the input/output characteristics in the low temperature range described above, the disclosure may provide a non-aqueous electrolyte secondary battery and a non-aqueous electrolyte for the secondary battery which can improve the high temperature characteristics (high temperature durability).

A first aspect of the disclosure relates to a non-aqueous electrolyte for a non-aqueous electrolyte secondary battery. The non-aqueous electrolyte contains a difluorophosphate represented by the following formula (I) with 0.5% by mass or more and an organic sulfate ester salt represented by the following formula (II) with 0.1% by mass or more.

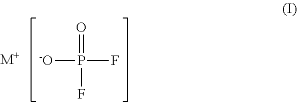

M⁺ in the formula (I) is an alkali metal ion.

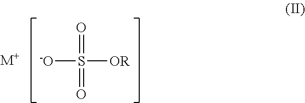

M⁺ in the formula (II) is a quaternary ammonium cation or a nitrogen-containing heteroaromatic ring cation, and R is an alkyl group having one to five carbon atoms in which an ether oxygen is optionally inserted.

The non-aqueous electrolyte having such a configuration contains both the difluorophosphate represented by the above formula (I) and the organic sulfate ester salt represented by the above formula (II), and thus can reduce the initial resistance in an extremely low temperature range and can improve the input/output characteristics. High temperature storage characteristics (high temperature durability) can also be improved.

The organic sulfate ester salt represented by the formula (II) may be at least one type selected from a group consisting of 1-ethyl-3-methylimidazolium methyl sulfate, 1-ethyl-3-methylimidazolium ethyl sulfate, 1,3-dimethylimidazolium methyl sulfate, 1,3-dimethylimidazolium ethyl sulfate, 1-butyl-3-methylimidazolium methyl sulfate, 1-butyl-3-methylimidazolium ethyl sulfate, N-methyl-N-propylpyrrolidinium methyl sulfate, and N-methyl-N-propylpyrrolidinium ethyl sulfate. By adopting such an organic sulfate ester salt, the input/output characteristics in an extremely low temperature range and the high temperature storage characteristics (high temperature durability) can be improved more favorably.

The M⁺ of the difluorophosphate represented by the above formula (I) may be a lithium ion. The non-aqueous electrolyte having the above configuration can be used as the non-aqueous electrolyte for the lithium ion secondary battery.

The non-aqueous electrolyte having the above configuration may include a solvent that belongs to at least one of carbonates as a non-aqueous solvent. By containing a solvent belonging to a carbonate (the non-aqueous solvent may be composed of a solvent belonging to a carbonate), a non-aqueous electrolyte used for a non-aqueous electrolyte secondary battery such as a lithium ion secondary battery is provided.

A second aspect of the disclosure provides a non-aqueous electrolyte secondary battery including a non-aqueous electrolyte. In the non-aqueous electrolyte secondary battery, the non-aqueous electrolyte satisfies one of the following conditions (1) and (2):

(1) the non-aqueous electrolyte contains a difluorophosphate represented by the above formula (I) and an organic sulfate ester salt represented by the above formula (II); and
(2) the non-aqueous electrolyte contains a reaction product of the difluorophosphate represented by the above formula (I) and a reaction product of the organic sulfate ester salt represented by the above formula (II).

A third aspect of the disclosure provides a method for manufacturing a non-aqueous electrolyte secondary battery, wherein the above non-aqueous electrolyte is used as a non-aqueous electrolyte.

The non-aqueous electrolyte secondary battery disclosed herein can improve the input/output characteristics in an extremely low temperature range and the high temperature storage characteristics (high temperature durability) as a result of constructing the non-aqueous electrolyte secondary battery using any one of the non-aqueous electrolytes described above.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view schematically showing an internal structure of a lithium ion secondary battery according to an embodiment of the disclosure; and

FIG. 2 is a schematic view showing a configuration of a wound electrode body of the lithium ion secondary battery of FIG. 1.

### DETAILED DESCRIPTION OF EMBODIMENTS

Hereinafter, some embodiments of an electrode structure disclosed herein will be described with reference to the drawings. Matters other than those particularly referred to in the present specification and necessary for carrying out the disclosure (for example, the general configuration and the manufacturing process of the entire secondary battery that do not characterize the disclosure) can be understood as matters of design choice for those skilled in the related art. The disclosure can be carried out based on contents disclosed in the present specification and common knowledge in the technical field.

In the present specification, the term “secondary battery” refers to a general electric storage device that can be repeatedly charged and discharged, and is a term that includes electric storage elements such as so-called storage batteries and electric double layer capacitors. Hereinafter, the disclosure will be described in detail with reference to a lithium ion secondary battery in which the non-aqueous electrolyte disclosed herein is used as an example, but it is not intended to limit the disclosure to the lithium ion secondary battery described in the embodiments. For example, a secondary battery including a non-aqueous electrolyte such as a sodium ion secondary battery or a magnesium ion secondary battery may be used, and an electric double layer capacitor such as a lithium ion capacitor may be used.

The electrolyte for a lithium ion secondary battery disclosed herein usually contains a non-aqueous solvent and a supporting salt. A known non-aqueous solvent used for the electrolyte for the lithium ion secondary battery may be used, and specific examples thereof include carbonates, ethers, esters, nitriles, sulfones, and lactones. In embodiments, the non-aqueous solvent comprises carbonates. Examples of carbonates include ethylene carbonate (EC), propylene carbonate (PC), diethyl carbonate (DEC), dimethyl carbonate (DMC), ethylmethyl carbonate (EMC). These may be used singly or in combination of two or more.

In addition, a known supporting salt used as a supporting salt of an electrolyte for a lithium ion secondary battery can be used, and specific examples thereof include LiPF₆, LiBF₄, lithium bis(fluorosulfonyl)imide (LiFSI) and lithium bis(trifluoromethane)sulfonimide (LiTFSI). The concentration of the supporting salt in the electrolyte is not particularly limited, but is, for example, 0.5 mol/L or more and 5 mol/L or less, 0.7 mol/L or more and 2.5 mol/L or less, or 0.7 mol/L or more and 1.5 mol/L or less.

The content of difluorophosphate represented by the following formula (I) in the electrolyte for the lithium ion secondary battery disclosed herein is not particularly limited, but is, for example, 0.2% by mass or more, and may be 0.5% by mass or more in embodiments. If the content of the difluorophosphate is too small, it is difficult to improve input/output characteristics at an extremely low temperature and high temperature storage characteristics (high temperature durability) at the same time. The upper limit of the content of the difluorophosphate is not particularly set, but may be 1.5% by mass or less in embodiments. By setting the content of the difluorophosphate within the above range, both of the input/output characteristics at an extremely low temperature and the high temperature storage characteristics (high temperature durability) can be suitably improved. Further, the content of organic sulfate ester salt represented by the following formula (II) may be 0.1% by mass or more in embodiments. If the content of the organic sulfate ester salt is too small, it is difficult to improve the input/output characteristics at an extremely low temperature range and the high temperature storage characteristics (high temperature durability) at the same time. The upper limit of the content of the organic sulfate ester salt is not particularly set, but may be 1.5% by mass or less in embodiments. By setting the content of the organic sulfate ester salt within the above range, both of the input/output characteristics at an extremely low temperature and the high temperature storage characteristics (high temperature durability) can be suitably improved.

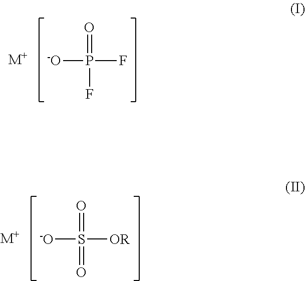

The inventor conducted various analyses on the lithium ion secondary battery using the electrolyte described above. Results of an X-ray photoelectron spectroscopy (XPS) analysis conducted on a film formed on the electrode surface showed a remarkable peak attributed to POx derived from the difluorophosphate represented by the above formula (I) (hereinafter sometimes referred to as “the above difluorophosphate”) and SOx derived from the organic sulfate ester salt represented by the above formula (II) (hereinafter sometimes referred to as “the above organic sulfate ester salt”). Since such a film containing the POx and the SOx has excellent low resistance, it can contribute to the improvement in the input/output characteristics at an extremely low temperature. Further, since the film is strong and has excellent stability, it can contribute to the improvement in the high temperature durability of the battery.

The electrolyte for the lithium ion secondary battery disclosed herein contains the above difluorophosphate and the above organic sulfate ester salt. The above difluorophosphate is a salt of a cation represented by M⁺ and an anion represented by PO₂F₂⁻. The above organic sulfate ester salt is a salt of a cation represented by the M⁺ and an anion represented by ROSO₃⁻.

The M⁺ in the above difluorophosphate is an alkali metal ion, and for example, lithium ion, sodium ion, potassium ion or the like is used. In particular, when the M⁺ is the lithium ion, it can be suitably used for the non-aqueous electrolyte for the lithium ion secondary battery.

When the M⁺ in the above organic sulfate ester salt is a quaternary ammonium cation, the quaternary ammonium cation is represented by N(R¹)₄⁺. Here, R¹ is each an alkyl group having 1 to 12 carbon atoms. In embodiments, two R¹s are bonded to each other to form a heterocycle with the bonded nitrogen atom.

The alkyl group having 1 to 12 carbon atoms and represented by R¹ may be linear, branched, or cyclic, and examples thereof include a methyl group, an ethyl group, a propyl group, an isopropyl group, a butyl group, an iso-butyl group, a tert-butyl group, a pentyl group, an iso-pentyl group, a tert-pentyl group, a hexyl group, a cyclohexyl group, a heptyl group, a 2-ethylhexyl group, an octyl group, a nonyl group, an iso-nonyl group, a decyl group, an undecyl group, and a dodecyl group. In embodiments, the alkyl group may have 1 to 6 carbon atoms. In other embodiments, the alkyl group may have 1 to 4 carbon atoms.

When two R¹s are bonded to each other to form a heterocycle with the bonded nitrogen atom, examples of the heterocycle include an ethyleneimine ring, an azacyclobutane ring, a pyrrolidine ring, a piperidine ring, a hexamethyleneimine ring, a heptamethyleneimine ring, and an octamethyleneimine ring. In embodiments, the heterocycle comprises a pyrrolidine ring, a piperidine ring, or both. In some embodiments, the heterocycle is a pyrrolidine ring. In embodiments, two such heterocycles may be formed. In other embodiments, one heterocycle is formed, and the remaining two R¹s are alkyl groups having 1 to 6 carbon atoms (such as 1 to 4 carbon atoms).

When the M⁺ in the above organic sulfate ester salt is a nitrogen-containing heteroaromatic ring cation, examples of the nitrogen-containing heteroaromatic ring include a pyrrole ring, a pyridine ring, a pyrimidine ring, a pyrazine ring, and an N-substituted imidazole ring, an N-substituted pyrazole ring, and an N-substituted triazole ring. When the nitrogen-containing heteroaromatic ring is N-substituted, it may be N-substituted with an alkyl group having 1 to 6 carbon atoms in embodiments. In other embodiments, the nitrogen-containing heteroaromatic ring may be N-substituted with an alkyl group having 1 to 4 carbon atoms. The alkyl group having 1 to 6 carbon atoms may be branched or cyclic, and examples thereof include a methyl group, an ethyl group, a propyl group, an isopropyl group, a butyl group, an iso-butyl group, a tert-butyl group, a pentyl group, an iso-pentyl group, a tert-pentyl group, a hexyl group, and a cyclohexyl group.

The number of ether oxygens inserted into the alkyl group having 1 to 5 carbon atoms and represented by R in the above organic sulfate ester salt is not particularly limited, and is 2 or less in embodiments. The alkyl group having 1 to 5 carbon atoms may be linear or branched, and examples thereof include a methyl group, an ethyl group, a propyl group, an isopropyl group, a butyl group, an iso-butyl group, a tert-butyl group, a pentyl group, an iso-pentyl group, a tert-pentyl group, a methoxymethyl group, a methoxyethyl group, an ethoxymethyl group, an ethoxyethyl group, a dimethoxymethyl group, and a methyldi (oxyethylene) group. To particularly enhance the effects of the disclosure, R may be a methyl group or an ethyl group in embodiments. In some embodiments, R is a methyl group.

In embodiments, the M⁺ in the above organic sulfate ester salt is an ammonium cation having four alkyl groups having 1 to 4 carbon atoms, a pyrrolidinium cation having two alkyl groups having 1 to 4 carbon atoms, or an imidazolium cation substituted with an alkyl group having 1 to 6 carbon atoms. In embodiments, the M⁺ in the above organic sulfate ester salt is an imidazolium cation substituted with an alkyl group having 1 to 6 carbon atoms, which may particularly enhance the effect of lowering the resistance of the lithium ion secondary battery. In some embodiments, the M⁺ in the above organic sulfate ester salt is an imidazolium cation substituted with an alkyl group having 1 to 4 carbon atoms.

The electrolyte for the lithium ion secondary battery disclosed herein may contain one type of the above organic sulfate ester salt alone, or may contain two or more types of the above organic sulfate ester salt. In embodiments, the above organic sulfate ester salt is at least one type selected from the group consisting of 1-ethyl-3-methylimidazolium methyl sulfate, 1-ethyl-3-methylimidazolium ethyl sulfate, 1,3-dimethylimidazolium methyl sulfate, 1,3-dimethylimidazolium ethyl sulfate, 1-butyl-3-methylimidazolium methyl sulfate, 1-butyl-3-methylimidazolium ethyl sulfate, N-methyl-N-propylpyrrolidinium methyl sulfate, and N-methyl-N-propylpyrrolidinium ethyl sulfate.

The non-aqueous electrolyte for the lithium ion secondary battery disclosed herein may contain other components as long as the effects of the disclosure are not significantly impaired. Examples of the other components include gas generating agents such as biphenyl (BP) and cyclohexylbenzene (CHB), film forming agents, dispersants, and thickeners.

The electrolyte for the lithium ion secondary battery disclosed herein can be prepared by mixing the above components according to a known method. The method for preparing the electrolyte may be a known method in the related art, and detailed description thereof will be omitted. Further, the electrolyte for the lithium ion secondary battery disclosed herein can be used for a lithium ion secondary battery according to a known method. Furthermore, the manufacturing method of the lithium ion secondary battery disclosed herein is a manufacturing method of a secondary battery provided with the electrolyte for the lithium ion secondary battery described above. A method of manufacturing a secondary battery using an electrolyte other than the electrolyte disclosed herein may be a known method in the related art, and detailed description thereof will be omitted.

Next, an outline of a configuration of the lithium ion secondary battery including the electrolyte for the lithium ion secondary battery according to the present embodiment will be described below with reference to the drawings. In the following drawings, the same reference signs are given to the members and portions that have the same effect. The dimensional relationships (length, width, thickness, etc.) in the drawings do not show the actual dimensional relationships. Hereinafter, as an example, a rectangular lithium ion secondary battery including a flat wound electrode body is described, but the lithium ion secondary battery may be configured as a lithium ion secondary battery including a stacked electrode body. The lithium ion secondary battery can also be configured as a cylindrical lithium ion secondary battery, a laminated lithium ion secondary battery, or the like.

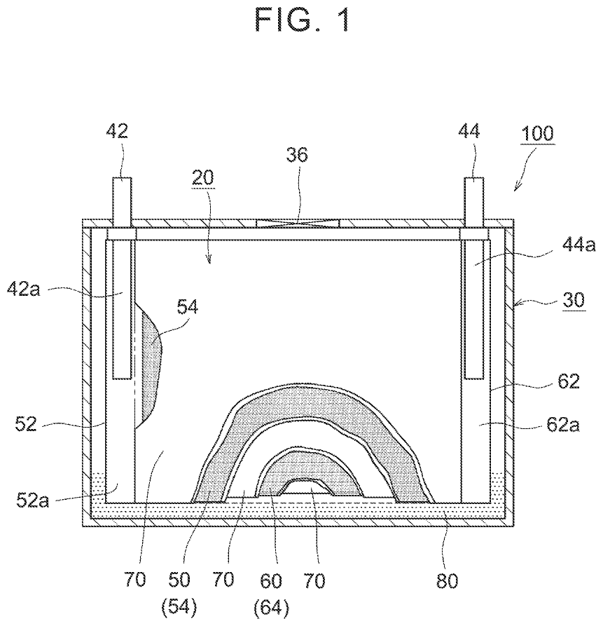

A lithium ion secondary battery 100 shown in FIG. 1 is a sealed battery constructed by housing a flat wound electrode body 20 and an electrolyte 80 in a flat rectangular battery case (that is, an outer container) 30. The battery case 30 is provided with a positive electrode terminal 42 and a negative electrode terminal 44 for external connection, and a thin safety valve 36 set to release the internal pressure of the battery case 30 when the internal pressure increases to a predetermined level or more. The battery case 30 is provided with an injection port (not shown) for injecting the electrolyte 80. The positive electrode terminal 42 is electrically connected to a positive electrode current collector plate 42a. The negative electrode terminal 44 is electrically connected to a negative electrode current collector plate 44a. As a material of the battery case 30, for example, a light-weight and highly heat-conductive metal material such as aluminum is used.

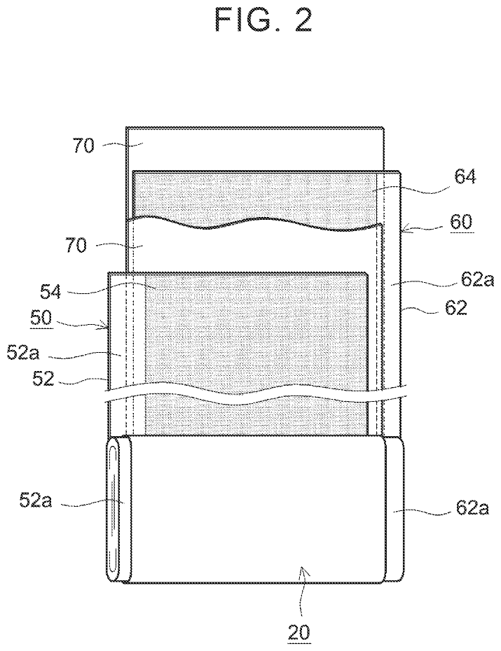

The wound electrode body 20 has a configuration in which, as shown in FIGS. 1 and 2, a positive electrode sheet 50 and a negative electrode sheet 60 are stacked via two long separator sheets 70 and are wound in the longitudinal direction. The positive electrode sheet 50 includes a positive electrode active material layer 54 provided on one surface or both surfaces (both surfaces in the present embodiment) of a long positive electrode current collector 52 along the longitudinal direction. The negative electrode sheet 60 includes a negative electrode active material layer 64 provided on one surface or both surfaces (both surfaces in the present embodiment) of a long negative electrode current collector 62 along the longitudinal direction. The positive electrode current collector plate 42a is joined to a positive electrode active material layer-free portion 52a (that is, the portion where the positive electrode current collector 52 is exposed without the positive electrode active material layer 54). The negative electrode current collector plate 44a is joined to a negative electrode active material layer-free portion 62a (that is, the portion where the negative electrode current collector 62 is exposed without the negative electrode active material layer 64). The positive electrode active material layer-free portion 52a and the negative electrode active material layer-free portion 62a are provided so as to protrude outward from both ends of the wound electrode body 20 in the winding axis direction (that is, the sheet width direction orthogonal to the longitudinal direction).

As the positive electrode sheet 50 and the negative electrode sheet 60, those used in the lithium ion secondary battery of the related art can be used without particular limitation. A typical mode is described below.

Examples of the positive electrode current collector 52 that constitutes the positive electrode sheet 50 include aluminum foil. Examples of the positive electrode active material contained in the positive electrode active material layer 54 include lithium transition metal oxides (e.g., LiNi_{1/3}Co_{1/3}Mn_{1/3}O₂, LiNiO₂, LiCoO₂, LiFeO₂, LiMn₂O₄, LiNi_{0.5}Mn_{1.5}O₄), and lithium transition metal phosphate compounds (e.g., LiFePO₄). The positive electrode active material layer 54 may include components other than the active material, such as a conductive material and a binder. As the conductive material, for example, carbon black such as acetylene black (AB) and other carbon materials such as graphite can be used in embodiments. As the binder, for example, polyvinylidene fluoride (PVDF) or the like can be used.

Examples of the negative electrode current collector 62 that constitutes the negative electrode sheet 60 include copper foil. As the negative electrode active material contained in the negative electrode active material layer 64, a carbon material such as graphite, hard carbon, and soft carbon can be used. In embodiments, the negative electrode active material comprises graphite. The graphite may be natural graphite or artificial graphite, and may be covered with an amorphous carbon material. The negative electrode active material layer 64 may include components other than the active material, such as a binder and a thickener. As the binder, for example, styrene butadiene rubber (SBR) or the like can be used. As the thickener, for example, carboxymethyl cellulose (CMC) or the like can be used.

As the separator 70, a porous sheet (film) made of polyolefin such as polyethylene (PE) or polypropylene (PP) may be used in embodiments. Such a porous sheet may have a single-layer structure or a stacked structure of two or more layers (for example, a three-layer structure in which a PP layer is laminated on both surfaces of a PE layer). A heat resistant layer (HRL) may be provided on the surface of the separator 70. The air permeability of the separator 70 obtained by the Gurley test method is not particularly limited, but is 350 seconds/100 cc or less in embodiments.

As the electrolyte 80, the electrolyte for the lithium ion secondary battery according to the present embodiment described above is used. Note that FIG. 1 does not strictly show the amount of the electrolyte 80 to be injected into the battery case 30.

The lithium ion secondary battery 100 configured as described above can be used for various purposes. Suitable applications include a driving power source mounted on vehicles such as electric vehicles (EVs), hybrid vehicles (HVs), and plug-in hybrid vehicles (PHVs). The lithium ion secondary battery 100 can also be used in the mode of an assembled battery, in which a plurality of batteries is typically connected in series and/or in parallel.

Examples of the disclosure will be described below, but it is not intended to limit the disclosure to the examples shown in the Examples.

### Preparation of Non-Aqueous Electrolyte

As the non-aqueous solvent, a mixed solvent containing ethylene carbonate (EC), dimethyl carbonate (DMC), and ethyl methyl carbonate (EMC) at a volume ratio of 30:40:30 was prepared. LiPF₆ serving as a supporting salt was dissolved in the mixed solvent at a concentration of 1.0 mol/L, and the additive shown in Table 1 (the above difluorophosphate or the above organic sulfate ester salt) was dissolved in the mixed solvent by an amount shown in Table 1 to prepare the electrolyte for each Example and each Comparative Example.

### Preparation of Lithium Ion Secondary Battery for Evaluation

LiNi_{1/3}Co_{1/3}Mn_{1/3}O₂ (LNCM) serving as a positive electrode active material powder, acetylene black (AB) serving as a conductive material, and polyvinylidene fluoride (PVdF) serving as a binder were mixed with N-methylpyrrolidone (NMP) at a mass ratio of LNCM:AB:PVdF=87:10:3 to prepare a slurry for forming a positive electrode active material layer. A positive electrode sheet was produced by applying the slurry to an aluminum foil and drying it. As a negative electrode active material, a natural graphite-based carbon material (C) having an average particle diameter of 20 μm, styrene-butadiene rubber (SBR) serving as a binder, and carboxymethyl cellulose (CMC) serving as a thickener were mixed with ion-exchanged water at a mass ratio of C:SBR:CMC=98:1:1 to prepare a slurry for forming a negative electrode active material layer. A negative electrode sheet was produced by applying the slurry to a copper foil and drying it. Further, as the separator, a polyolefin porous film having a three-layer structure of PP, PE, PP in this order and having an air permeability of 200 seconds/100 cc obtained by the Gurley test method was prepared. The positive electrode sheet and the negative electrode sheet thus produced were overlapped with each other via the separators to produce an electrode body. After attaching current collector terminals to such an electrode body, the electrode body was housed and sealed in a laminated case together with the electrolyte prepared above. In this way, lithium ion secondary batteries for evaluation including the electrolytes for the Examples and the Comparative Examples were produced.

### Activation Process

Each of the lithium ion secondary batteries for evaluation prepared above was placed in a constant temperature bath kept at 25° C. Each of the lithium ion secondary batteries for evaluation was subjected to constant current charging at a current value of 0.3 C to 4.10 V, and then was subjected to constant current discharging at a current value of 0.3 C to 3.00 V. This charging/discharging was repeated three times.

### Initial Characteristic Evaluation

Each of the activated lithium ion secondary batteries for evaluation was placed in a constant temperature bath kept at 25° C. After performing constant current charging for each of the lithium ion secondary batteries for evaluation at a current value of 0.2 C to 4.10 V, constant voltage charging was performed until the current value became 1/50 C to obtain a fully charged state (state of charge (SOC): 100%). Then, constant current discharging was performed at a current value of 0.2 C to 3.00 V. The discharge capacity at this time was measured and used as the initial capacity. Each of the activated lithium ion secondary batteries for evaluation was placed in a constant temperature bath kept at 25° C. and constant current charging was performed until the SOC reached 50% at a current value of 0.3 C. Then, in a constant temperature bath kept at −10° C., discharging and charging were performed at current values of 3 C, 5 C, 10 C, and 15 C for 10 seconds, and the battery voltages were measured each time. The current values and the voltage values were plotted with the current value on the horizontal axis and the voltage value on the vertical axis, and the IV resistance was determined from the inclination of the linear approximation line. This IV resistance was used as the initial resistance. Regarding the initial resistance of Comparative Example 1 as 100, the ratios of the initial resistance of the Examples and other Comparative Examples were calculated. The obtained ratios are shown in Table 1.

### High Temperature Storage Test

Each of the lithium ion secondary batteries for evaluation was charged until the SOC reached 100% at a current value of 0.3 C and then stored in a constant temperature bath kept at 60° C. for one month. Then, the discharge capacity of each lithium ion secondary battery for evaluation was measured by the same method as described above, and the discharge capacity at this time was determined as the battery capacity after high temperature storage. The capacity retention rate (%) was determined from the following formula: (battery capacity after high temperature storage/initial capacity)×100. The IV resistance (battery resistance after high temperature storage) of each lithium ion secondary battery for evaluation was measured by the same method as described above. The resistance increase rate (%) was determined from the following formula: {1−(resistance after high temperature storage/initial resistance)}×100. The results are shown in Table 1.

TABLE 1

| | | | | | | | Remaining | Resistance |
|---|---|---|---|---|---|---|---|---|
| | | | | | Initial resistance | | capacity | change after |
| | | | | | ratio | | after high | high |
| | Content of additives in non-aqueous electrolyte | | | | −10° C. | −10° C. | temperature | temperature |
| | Additive (I) | mass % | Additive (II) | mass % | input | output | storage (%) | storage (%) |
| Example 1 | LiPO₂F₂ | 1.5 | EMIm-MSfa | 0.5 | 78 | 59 | 90.6 | 2.5 |
| Example 2 | LiPO₂F₂ | 1.0 | EMIm-MSfa | 0.5 | 77 | 59 | 91.0 | 2.7 |
| Example 3 | LiPO₂F₂ | 0.5 | EMIm-MSfa | 0.5 | 80 | 62 | 90.2 | 3.2 |
| Example 4 | LiPO₂F₂ | 1.0 | EMIm-MSfa | 0.3 | 81 | 63 | 90.0 | 2.8 |
| Example 5 | LiPO₂F₂ | 1.0 | EMIm-MSfa | 1.0 | 82 | 64 | 89.2 | 3.0 |
| Example 6 | LiPO₂F₂ | 1.0 | EMIm-MSfa | 1.5 | 83 | 65 | 88.2 | 3.3 |
| Example 7 | LiPO₂F₂ | 1.0 | EMIm-MSfa | 0.1 | 83 | 66 | 90.1 | 3.9 |
| Example 8 | LiPO₂F₂ | 1.0 | EMIm-ESfa | 0.5 | 77 | 60 | 90.9 | 2.6 |
| Example 9 | LiPO₂F₂ | 1.0 | DMIm-MSfa | 0.5 | 77 | 59 | 90.3 | 2.9 |
| Example 10 | LiPO₂F₂ | 1.0 | BMIm-MSfa | 0.5 | 78 | 60 | 90.1 | 3.1 |
| Example 11 | LiPO₂F₂ | 1.0 | PYR13-MSfa | 0.5 | 77 | 61 | 90.2 | 2.4 |
| Example 12 | NaPO₂F₂ | 1.0 | EMIm-MSfa | 0.5 | 78 | 60 | 90.5 | 3.0 |
| Comparative | Not | — | Not | — | 100 | 100 | 85.0 | 9.4 |
| Example 1 | contained | | contained | | | | | |
| Comparative | LiPO₂F₂ | 1.0 | Not | — | 84 | 78 | 87.9 | 4.4 |
| Example 2 | | | contained | | | | | |
| Comparative | Not | — | EMIm-MSfa | 0.5 | 80 | 71 | 80.7 | 6.1 |
| Example 3 | contained | | | | | | | |
| Comparative | LiPO₂F₂ | 1.0 | EMIm-MS | 0.5 | 87 | 81 | 86.9 | 5.2 |
| Example 4 | | | | | | | | |
| Comparative | LiPO₂F₂ | 1.0 | EMIm-FSI | 0.5 | 92 | 102 | 82.5 | 8.9 |
| Example 5 | | | | | | | | |
| Comparative | LiPO₂F₂ | 1.0 | EMIm-MSfa | 0.05 | 86 | 79 | 85.5 | 4.9 |
| Example 6 | | | | | | | | |
| Comparative | LiPO₂F₂ | 0.1 | EMIm-MSfa | 0.5 | 82 | 70 | 81.1 | 6.0 |
| Example 7 | | | | | | | | |

Cation species of electrolyte additive
EMIm: 1-ethyl-3-methylimidazolium
DMIm: 1,3-dimethylimidazolium
BMIm: 1-butyl-3-methylimidazolium
PYR13: N-methyl-N-propylpyrrolidinium
Anion species of electrolyte additive
MSfa: CH₃OSO₃⁻
ESfa: CH₃CH₂OSO₃⁻
FSI: (FSO₂)₂N⁻
MS: CH₃SO₃⁻

Hereinafter, Table 1 will be described. The term “at low temperature” described below means at −10° C. Further, “mass %” in Table 1 represents the ratio (%) of the mass of the additive (I) (the above difluorophosphate) or the additive (II) (the above organic sulfate ester salt) contained in the non-aqueous electrolyte (100 mass %). Comparative Example 1 represents an electrolyte that is free of additives and that is commonly used in the related art. In Comparative Example 2, only LiPO₂F₂ was added as the additive with 1.0% by mass, and in Comparative Example 3, only EMIm-MSfa was added as the additive with 0.5% by mass. Comparing Comparative Example 3 with Examples 1 to 3 (in which LiPO₂F₂ is added within a range of 0.5% by mass to 1.5% by mass and EMIm-MSfa is added with 0.5% by mass), it can be understood that in Examples 1 to 3, as compared with Comparative Example 3, the initial input/output resistances at low temperature and the resistance increase rates after high temperature storage were suitably reduced, and further, the capacity retention rates after high temperature storage were suitably increased. In Comparative Example 7 (in which LiPO₂F₂ is added with 0.1% by mass and EMIm-MSfa is added with 0.5% by mass), the resistance increase rate after high temperature storage was significantly higher than 4.0% (the resistance increase rate after high temperature storage is preferably 4.0% or less), and the capacity retention rate after high temperature storage significantly fell below 88% (the capacity retention rate after high temperature storage is preferably 88% or more). Thus, it can be understood that neither the input/output characteristics at low temperature nor the high temperature characteristics (high temperature durability) are achieved.

Comparing Comparative Example 2 with Examples 2 and 4 to 7 (wherein LiPO₂F₂ is added with 1.0% by mass and EMIm-MSfa is added within a range of 0.1% by mass to 1.5% by mass), it can be understood that in Examples 2 and 4 to 7, as compared with Comparative Example 2, the initial input/output resistances at low temperature and the resistance increase rates after high temperature storage were suitably reduced, and further, the capacity retention rates after high temperature storage were suitably increased. In Comparative Example 6 (in which LiPO₂F₂ is added with 1.0% by mass and EMIm-MSfa is added with 0.05% by mass), the resistance increase rate after high temperature storage was higher than 4.0% (the resistance increase rate after high temperature storage is preferably 4.0% or less), and the capacity retention rate after high temperature storage significantly fell below 88% (the capacity retention rate after high temperature storage is preferably 88% or more). Thus, it can be understood that neither the input/output characteristics at low temperature nor the high temperature characteristics (high temperature durability) are achieved.

Comparing Example 2 and Example 8, only very small differences were confirmed in the initial input/output resistances at low temperature, the resistance increase rates after high temperature storage, and the capacity retention rates after high temperature storage. Thus, it can be understood that the above organic sulfate ester salt can be used regardless of whether the sulfate ester part of the above organic sulfate ester salt is MSfa or ESfa. However, in Comparative Examples 4 and 5, the resistance increase rates after high temperature storage were significantly higher than 4.0% (the resistance increase rate after high temperature storage is preferably 4.0% or less), and the capacity retention rates after high temperature storage significantly fell below 88% (the capacity retention rate after high temperature storage is preferably 88% or more). Thus, it can be understood that neither the input/output characteristics at low temperature nor the high temperature characteristics (high temperature durability) are achieved. Therefore, it can be understood that, when the sulfate ester part of the above organic sulfate ester salt is MS or FSI, it is difficult to improve the input/output characteristics at low temperature and the high temperature characteristics (high temperature durability) at the same time. Further, comparing Example 2 and Examples 9 to 11, only very small differences were confirmed in the initial input/output resistances at low temperature, the resistance increase rates after high temperature storage, and the capacity retention rates after high temperature storage. Thus, it can be understood that the above organic sulfate ester salt can be used regardless of whether the organic cation part of the above organic sulfate ester salt is EMIm, DMIm, BMIm, or PYR13. Further, comparing Example 2 and Example 12, only very small differences were confirmed in the initial input/output resistances at low temperature, the resistance increase rates after high temperature storage, and the capacity retention rates after high temperature storage. Thus, it can be understood that the above difluorophosphate can be used regardless of whether the metal ion of the above difluorophosphate is lithium ion or sodium ion.

From the above, it can be understood that the electrolyte for the lithium ion secondary battery according to the present embodiment suitably improves both the input/output characteristics at low temperature and the high temperature characteristics (high temperature durability). It can also be understood that the lithium ion secondary battery including such an electrolyte suitably improves both the input/output characteristics at low temperature and the high temperature characteristics (high temperature durability).

In addition, the inventor conducted the XPS analysis on a film on an electrode interface of the lithium ion secondary battery using the electrolyte described above. K-Alpha⁺ manufactured by Thermo Fisher Scientific was used for the XPS analysis, and the analysis was conducted according to the manual for the apparatus. Although details are not described, after the activation process, the XPS analysis on the film on the negative electrode interface of the lithium ion secondary batteries in Comparative Example 1 and Example 2 was conducted while maintaining an inert atmosphere, and as a result, a remarkable peak attributed to the SOx was observed in Example 2. In Comparative Example 1, such a peak was not observed. Further, in Example 2, as compared with Comparative Example 1, it was confirmed that the production of LiF was suppressed and the production of POx was accelerated (that is, POx/LiF changed). From the above, it can be considered that, in Example 2, the film containing POx and SOx was formed on the negative electrode interface, and such a film contributed to improving the input/output characteristics at low temperature and the high temperature characteristics (high temperature durability). Further, in ¹⁹F-NMR measurement, a peak of LiPO₂F₂ is observed (detected as having a peak intensity much higher than that of LiPO₂F₂ which can be generated from LiPF₆ serving as a supporting salt), whereby the presence of a reaction product of the above difluorophosphate can be shown.

Specific examples of the disclosure have been described above in detail, but these are merely examples and do not limit the disclosure. The disclosure includes various modifications and changes of the specific examples illustrated above.

What is claimed is:

1. A non-aqueous electrolyte for a non-aqueous electrolyte secondary battery, the non-aqueous electrolyte containing a difluorophosphate represented by a following formula (I) with 0.5% by mass or more and an organic sulfate ester salt represented by a following formula (II) with 0.1% by mass or more, wherein: 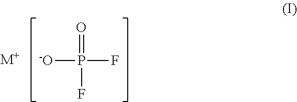
M⁺ in the formula (I) is an alkali metal ion; and 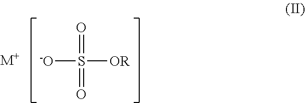
M⁺ in the formula (II) is a quaternary ammonium cation or a nitrogen-containing heteroaromatic ring cation, and R is an alkyl group having one to five carbon atoms in which an ether oxygen is optionally inserted.

2. The non-aqueous electrolyte according to claim 1, wherein the organic sulfate ester salt represented by the formula (II) is at least one selected from a group consisting of 1-ethyl-3-methylimidazolium methyl sulfate, 1-ethyl-3-methylimidazolium ethyl sulfate, 1,3-dimethylimidazolium methyl sulfate, 1,3-dimethylimidazolium ethyl sulfate, 1-butyl-3-methylimidazolium methyl sulfate, 1-butyl-3-methylimidazolium ethyl sulfate, N-methyl-N-propylpyrrolidinium methyl sulfate, and N-methyl-N-propylpyrrolidinium ethyl sulfate.

3. The non-aqueous electrolyte according to claim 1, wherein the M⁺ of the difluorophosphate represented by the formula (I) is a lithium ion.

4. The non-aqueous electrolyte according to claim 1, comprising a solvent that belongs to at least one of carbonates as a non-aqueous solvent.

5. A non-aqueous electrolyte secondary battery, which is a secondary battery including a non-aqueous electrolyte, wherein the non-aqueous electrolyte satisfies one of the following conditions (1) and (2):
(1) the non-aqueous electrolyte contains a difluorophosphate represented by the following formula (I) 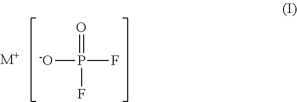
and an organic sulfate ester salt represented by the following formula (II), wherein 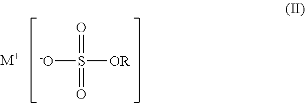
M⁺ in the formula (I) is an alkali metal ion, and
M⁺ in the formula (II) is a quaternary ammonium cation or a nitrogen-containing heteroaromatic ring cation, and R is an alkyl group having one to five carbon atoms in which an ether oxygen is optionally inserted; and
(2) the non-aqueous electrolyte contains a reaction product of the difluorophosphate represented by the formula (I) and a reaction product of the organic sulfate ester salt represented by the formula (II).

6. The non-aqueous electrolyte secondary battery according to claim 5, wherein the organic sulfate ester salt represented by the formula (II) is at least one selected from a group consisting of 1-ethyl-3-methylimidazolium methyl sulfate, 1-ethyl-3-methylimidazolium ethyl sulfate, 1,3-dimethylimidazolium methyl sulfate, 1,3-dimethylimidazolium ethyl sulfate, 1-butyl-3-methylimidazolium methyl sulfate, 1-butyl-3-methylimidazolium ethyl sulfate, N-methyl-N-propylpyrrolidinium methyl sulfate, and N-methyl-N-propylpyrrolidinium ethyl sulfate.

7. The non-aqueous electrolyte secondary battery according to claim 5, wherein the M⁺ of the difluorophosphate represented by the formula (I) is a lithium ion.

8. The non-aqueous electrolyte secondary battery according to claim 5, wherein the non-aqueous electrolyte comprises a solvent that belongs to at least one of carbonates as a non-aqueous solvent.

9. A method for manufacturing a non-aqueous electrolyte secondary battery, wherein the non-aqueous electrolyte according to claim 1 is used as a non-aqueous electrolyte.
